(19) United States
(12) Patent Application Publication
(10) Pub. No.: US 2023/0168723 A1
(43) Pub. Date: Jun. 1, 2023

(54) THERMAL RELIEF IMPLEMENTING METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Dongxin LI, Beijing (CN); Xin JIN, Beijing (CN)

(73) Assignee: BEIJING BAIDU NETCOM SCIENCE TECHNOLOGY CO., LTD., Beijing (CN)

(21) Appl. No.: 17/893,415

(22) Filed: Aug. 23, 2022

(30) Foreign Application Priority Data
Nov. 29, 2021 (CN) 202111435042.4

(51) Int. Cl. G06F 1/20

(52) U.S. Cl. CPC G06F 1/20

(57) ABSTRACT

A thermal relief implementing method and apparatus, an electronic device and a storage medium, which relate to the field of artificial intelligence, such as artificial intelligence chips, are disclosed. The method may include: determining a number of reflow holes for any pin, and determining a number of connection layers for thermal relief connection according to the number of the reflow holes; adjusting at least one parameter of the number of the reflow holes, the number of the connection layers, or widths of connection points of at least one layer until predetermined heat dissipation constraint and impedance design requirement are met; and taking current parameter values as required thermal-relief design parameters.

### CROSS-REFERENCE TO RELATED APPLICATIONS

The present disclosure claims the priority and benefit of Chinese Patent Application No. 202111435042.4, filed on Nov. 29, 2021, entitled “THERMAL RELIEF IMPLEMENTING METHOD AND APPARATUS, ELECTRONIC DEVICE AND STORAGE MEDIUM.” The disclosure of the above application is incorporated herein by reference in its entirety.

### TECHNICAL FIELD

The present disclosure relates to the field of artificial intelligence technologies, particularly to the field of artificial intelligence chips, and more particularly to a thermal relief implementing method, an electronic device and a storage medium.

### BACKGROUND

For a dual in-line package (DIP) connector, thermal relief is a common design method, and mainly refers to a connection method between a pad and copper foil.

In a traditional electronic system design, due to a low signal transmission rate, a small number of layers of a printed circuit board (PCB), or the like, the thermal relief is generally used for welding within three layers close to a welding surface during usage to guarantee a welding yield.

However, in a modern high-speed digital circuit design, the signal transmission rate is greatly improved, and the number of the layers of the PCB is significantly increased. In this case, if the above design method is still adopted, a signal return path is too long, and return path impedance is large, resulting in a signal integrity problem, or the like. However, if only a number of connection layers and a connection area of each layer are increased, a thermal conductivity of the welding surface is increased, resulting in a poor welding problem, a sealing-off problem, and other welding problems.

### SUMMARY

The present disclosure provides a thermal relief implementing method, an electronic device and a storage medium.

A thermal relief implementing method includes determining a number of reflow holes for any pin, and determining a number of connection layers for thermal relief connection according to the number of the reflow holes; and adjusting at least one parameter of: the number of the reflow holes, the number of the connection layers, or widths of connection points of at least one layer until predetermined a heat dissipation constraint and an impedance design requirement are met, and taking current parameter values as required thermal-relief design parameters.

An electronic device includes at least one processor; and a memory connected with the at least one processor communicatively; wherein the memory stores instructions executable by the at least one processor to enable the at least one processor to perform the method as mentioned above.

There is provided a non-transitory computer readable storage medium with computer instructions stored thereon, wherein the computer instructions are used for causing a computer to perform the method as mentioned above.

It should be understood that the statements in this section are not intended to identify key or critical features of the embodiments of the present disclosure, nor limit the scope of the present disclosure. Other features of the present disclosure will become apparent from the following description.

### BRIEF DESCRIPTION OF THE DRAWINGS

The drawings are used for better understanding the present solution and do not constitute a limitation of the present disclosure. In the drawings,

FIG. 1 is a flow chart of a thermal relief implementing method according to a first embodiment of the present disclosure;

FIG. 2 is a schematic diagram of cross-shaped thermal relief in the present disclosure;

FIG. 3 is a schematic diagram of a connection layer and a non-connection layer in the present disclosure;

FIG. 4 is a flow chart of the thermal relief implementing method according to a second embodiment of the present disclosure;

FIG. 5 is a schematic structural diagram of a thermal relief implementing apparatus 500 according to an embodiment of the present disclosure; and

FIG. 6 shows a schematic block diagram of an electronic device 600 which may be configured to implement the embodiments of the present disclosure.

### DETAILED DESCRIPTION OF PREFERRED EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and structures are omitted in the descriptions below.

In addition, it should be understood that the term “and/or” only describes an association relationship between associated objects, and indicates that three relationships may exist. For example, A and/or B may indicate three cases: only A exists; both A and B exist; and only B exists. In addition, in this specification, the symbol “/” generally indicates that associated objects have a relationship of “or”.

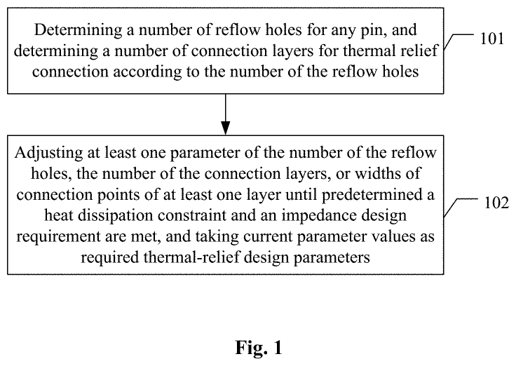

FIG. 1 is a flow chart of a thermal relief implementing method according to a first embodiment of the present disclosure. As shown in FIG. 1, the method includes the following implementation steps:

Step 101: determining a number of reflow holes for any pin, and determining a number of connection layers for thermal relief connection according to the number of the reflow holes.

Step 102: adjusting at least one parameter of: the number of the reflow holes, the number of the connection layers, or widths of connection points of at least one layer, until a predetermined heat dissipation constraint and an impedance design requirement are met, and taking current parameter values as required thermal-relief design parameters.

It is observed that in the solution of the above-mentioned method embodiment, any of multiple parameters, such as the number of the reflow holes, the number of the connection layers, the widths of the connection points, or the like, may be adjusted, such that designed thermal relief may meet the heat dissipation constraint and impedance design requirement at the same time, that is, considers lower return path impedance and better processability at the same time, thereby guaranteeing integrity of signals as far as possible, and solving a poor welding problem, a sealing-off problem, and other welding problems as far as possible.

Usually, corresponding signal pins are occupied for signal fanout of a DIP connector, other pins are a ground pin GND and a power pin VCC, GND may provide a signal return path and reference, and VCC may provide power.

For any pin required to be processed using a thermal relief method, the number of the reflow holes may be determined firstly, and the reflow holes may also be called via holes.

In one embodiment of the present disclosure, the reflow holes may be distributed within a predetermined range around the pin. For example, the reflow holes are uniformly distributed. A specific value of the predetermined range may be determined according to actual requirements, for example, may be less than 30 mils. Uniformly distributing the reflow holes may improve the processability.

The specific number of the reflow holes may be determined according to actual requirements, for example, may be an initial value set experientially.

Then, the number of the connection layers for thermal relief connection may be determined according to the number of the reflow holes. In one embodiment of the present disclosure, the sum of the number of the reflow holes and 1 may be calculated to obtain a first calculation result, a ratio of a maximum connectable layers' number to the first calculation result may be calculated to obtain a second calculation result, and the number of the connection layers is less than or equal to the maximum connectable layers' number; and then, the second calculation result may be rounded up to an integer, so as to obtain a third calculation result, and then, an integer greater than or equal to the third calculation result may be used as the required number of the connection layers.

That is,

$$N \geq Roundup ( \frac{{N}_{L}}{{n}_{x} + 1} ) \qquad ( 1 )$$

where N_{L} represents the maximum connectable layers' number, nₓ represents the number of the reflow holes, Roundup represents a round-up function, and N represents the number of the connection layers.

A specific value of the maximum connectable layers' number may be determined according to actual requirements, and usually, the maximum connectable layers' number is unchanged for any PCB, such as a to-be-processed PCB.

In this way, the number of the connection layers may be accurately and efficiently determined, such that a good foundation is laid for a subsequent processing operation.

After the number of the connection layers is determined, at least one of the number of the reflow holes, the number of the connection layers, or the widths of the connection points of the at least one layer may be adjusted until the predetermined heat dissipation constraint and the impedance design requirement are met.

In one embodiment of the present disclosure, if the heat dissipation constraint is determined to be met, a first processing operation may be performed, otherwise, the widths of the connection points of the at least one layer may be adjusted until the heat dissipation constraint is met, and then, the first processing operation may be performed; and the first processing operation may include: simulating an impedance change of the reflow hole, and in response to determining that the impedance design requirement is met according to a simulation result, adjusting at least one parameter of: the number of the reflow holes, the number of the connection layers or the widths of the connection points of the at least one layer until the impedance design requirement is met.

In one embodiment of the present disclosure, connection types of respective connection layers may also be determined, and correspondingly, whether the heat dissipation constraint is met may be determined according to the number of the connection layers, the widths of the connection points of the layers, the number of the connection points corresponding to the connection types of the layers, or the like, thereby improving the accuracy of a determination result, or the like.

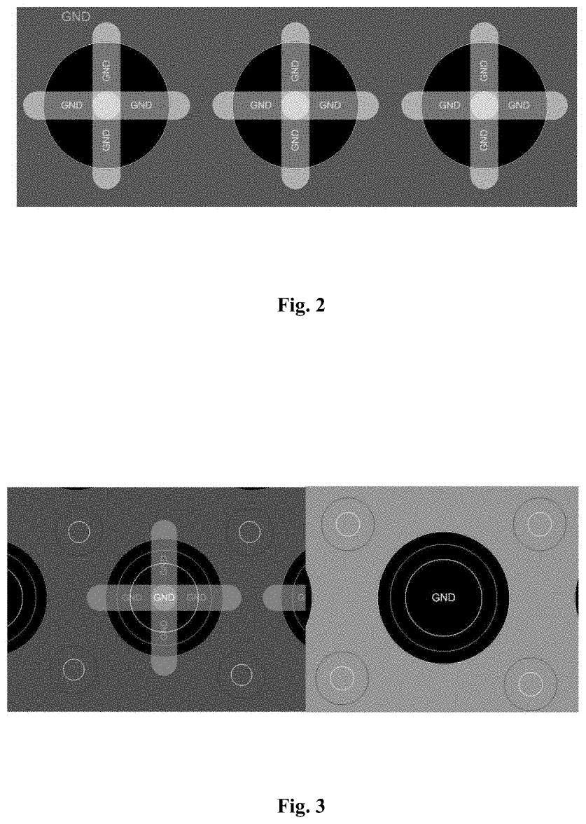

That is, after the number of the connection layers is determined according to the formula (1), the connection type of each layer (each connection layer) may also be determined. The connection type (i.e., the type of the thermal relief) may include a cross shape, a double cross shape, or the like. As shown in FIG. 2, FIG. 2 is a schematic diagram of a cross-shaped thermal relief in the present disclosure. The connection types of the layers may be the same or different. In order to simplify a design, or the like, the connection types of the layers may be the same.

In addition, different connection types correspond to respective numbers of the connection points; for example, usually, the cross-shaped thermal relief has 4 connection points, and the double-cross-shaped thermal relief has 8 connection points.

In one embodiment of the present disclosure, adjacent connection layers may be spaced apart by a same number of non-connection layers; that is, every two adjacent connection layers may be spaced apart by the same number of non-connection layers, for example, nₓ non-connection layers. The non-connection layers for spacing may be connected through the reflow holes to meet a signal ground return requirement; that is, the grounding return of the signals is realized. In one embodiment of the present disclosure, full connection of the maximum connectable layers' number may be realized through the reflow holes; that is, the reflow holes are required to be fully connected with the maximum connectable layers' number. With the processing operation, signal integrity, reliability, or the like, may be improved.

After the number of the connection layers, the connection types of the respective connection layers, or the like, are determined, a layout and connection design of a designated location of the thermal relief may be performed correspondingly, and whether the heat dissipation constraint is met may be determined according to the number of the connection layers, the widths of the connection points of the layers, the number of the connection points corresponding to the connection types of the respective connection layers, or the like. Initially, the widths of the connection points of the layers are default values.

In one embodiment of the present disclosure, a method for determining whether the heat dissipation constraint is met may include: taking any layer as a to-be-processed layer, and performing the following processing operations: obtaining a product of a number of connection points of the to-be-processed layer, widths of the connection points of the to-be-processed layer, a thickness of the to-be-processed layer and a heat dissipation coefficient per unit width and unit thickness to obtain a fourth calculation result, obtaining the sum of the fourth calculation results corresponding to the respective layers to obtain a fifth calculation result, and determining that the heat dissipation constraint is met if the fifth calculation result is less than or equal to a heat dissipation rate corresponding to a pin.

Assuming that the numbers of the connection points and the widths of the connection points of the layers are the same, then:

Σᵢ₌₁^{N}ε·nD·hᵢ≤E₀,N≤N_{L} (2)

where N represents the number of the connection layers, N_{L} represents the maximum connectable layers' number, n represents the number of the connection points of the to-be-processed layer, D represents the width of the connection point of the to-be-processed layer, hᵢ represents the thickness of the to-be-processed layer, E represents the heat dissipation coefficient per unit width and unit thickness, and E₀ represents the heat dissipation rate corresponding to the pin; that is, the heat dissipation rate on the pin is allowed under a condition of guaranteeing a welding yield.

In the formula (2), usually, for a to-be-processed PCB, the maximum connectable layers' number, the heat dissipation coefficient, the thicknesses of the layers and the heat dissipation rate are immutable, and then, in order to meet the requirement of the formula (2), only several other parameters, such as the number of the connection layers, the widths of the connection points, or the like, may be adjusted.

If the heat dissipation constraint is determined to be met according to the current parameters, the first processing operation may be directly performed, otherwise, the widths of the connection points of the at least one layer may be adjusted until the heat dissipation constraint is met, and then, the first processing operation may be performed. Usually, in order to simplify the design, the widths of the connection points of the layers may be uniformly adjusted; that is, the widths of the connection points of the layers may be the same before adjustment, and may also be the same after adjustment. The adjustment may refer to increase or decrease of the width of the connection point.

After the heat dissipation constraint is determined to be met, the impedance change of the reflow hole may be simulated by an impedance simulation tool, and if the impedance design requirement is determined not to be met according to a simulation result, at least one of the number of the reflow holes, the number of the connection layers or the widths of the connection points of the at least one layer may be adjusted until the impedance design requirement is met.

It is observed that when the impedance design requirement is determined not to be met according to the simulation result, the impedance design requirement may be met by adjusting one or any combination of the following parameters: the number of the reflow holes, the number of the connection layers or the widths of the connection points of the at least one layer.

Whether the adjustment is performed or not, once the impedance design requirement is determined to be met, the subsequent processing operation may be continued, and the subsequent processing operation may include: taking current parameter values as required thermal-relief design parameters, that is, taking the current number of the reflow holes, the current number of the connection layers, the current widths of the connection points, or the like, as the final thermal-relief design parameters.

In one embodiment of the present disclosure, the subsequent processing operation may also include: determining whether the heat dissipation constraint is met, and in response to determining that the heat dissipation constraint is met, taking the current parameter values as the required thermal-relief design parameters, and in response to determining that the heat dissipation constraint is not met, adjusting the widths of the connecting points of the at least one layer until the heat dissipation constraint is met, and taking the current parameter values as the required thermal-relief design parameters.

With the processing operation, the newly-obtained parameter values may be further ensured to accord with the heat dissipation constraint, thereby solving possible welding problems, or the like.

FIG. 3 is a schematic diagram of the connection layer and the non-connection layer in the present disclosure. As shown in FIG. 3, the diagram on the left represents the connection layer, and assuming that the thermal relief in the present disclosure is cross-shaped thermal relief, the diagram on the right represents the non-connection layer.

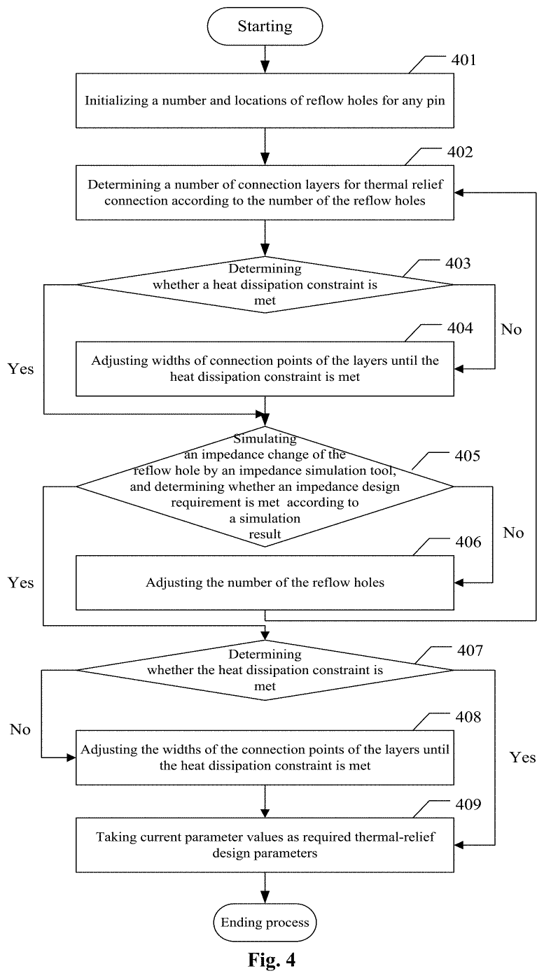

Based on the above descriptions, FIG. 4 is a flow chart of the thermal relief implementing method according to a second embodiment of the present disclosure. As shown in FIG. 4, the method includes the following implementation steps:

Step 401: initializing a number and locations of reflow holes for any pin.

The reflow holes may be uniformly distributed within a predetermined range around the pin.

Step 402: determining a number of connection layers for thermal relief connection according to the number of the reflow holes.

For example, the number of the connection layers may be determined according to the formula (1).

In addition, connection types of the layers may also be determined. In this embodiment, it is assumed that the connection types of the layers are the same, such as a cross shape.

Step 403: determining whether a heat dissipation constraint is met, if yes, executing step 405, and if no, executing step 404.

Whether the heat dissipation constraint is met may be determined according to the formula (1).

Step 404: adjusting widths of connection points of the layers until the heat dissipation constraint is met, and then, executing step 405.

In this embodiment, it is assumed that the widths of the connection points of the layers are the same.

Step 405: simulating an impedance change of the reflow hole by an impedance simulation tool, and determining whether an impedance design requirement is met according to a simulation result, if yes, executing step 407, and if no, executing step 406.

A method for simulating the impedance change of the reflow hole is known in the prior art.

Step 406: adjusting the number of the reflow holes, and then, executing step 402.

Step 407: determining whether the heat dissipation constraint is met, if yes, executing step 409, and if no, executing step 408.

Step 408: adjusting the widths of the connection points of the layers until the heat dissipation constraint is met, and then, executing step 409.

Step 409: taking current parameter values as required thermal-relief design parameters, and ending the process.

It should be noted that for simplicity of description, all the above-mentioned embodiments of the method are described as combinations of a series of acts, but those skilled in the art should understand that the present disclosure is not limited by the described order of acts, as some steps may be performed in other orders or simultaneously according to the present disclosure. Further, those skilled in the art should also understand that the embodiments described in this specification are preferred embodiments and that acts and modules referred to are not necessary for the present disclosure. In addition, for parts that are not described in detail in a certain embodiment, reference may be made to the related descriptions of other embodiments.

In a word, in the solution of the method embodiment of the present disclosure, the lower return path impedance and the better processability may be considered at the same time, and the reliability of the DIP connector in the use process is improved.

The above is a description of an embodiment of the method, and an embodiment of an apparatus according to the present disclosure will be further described below.

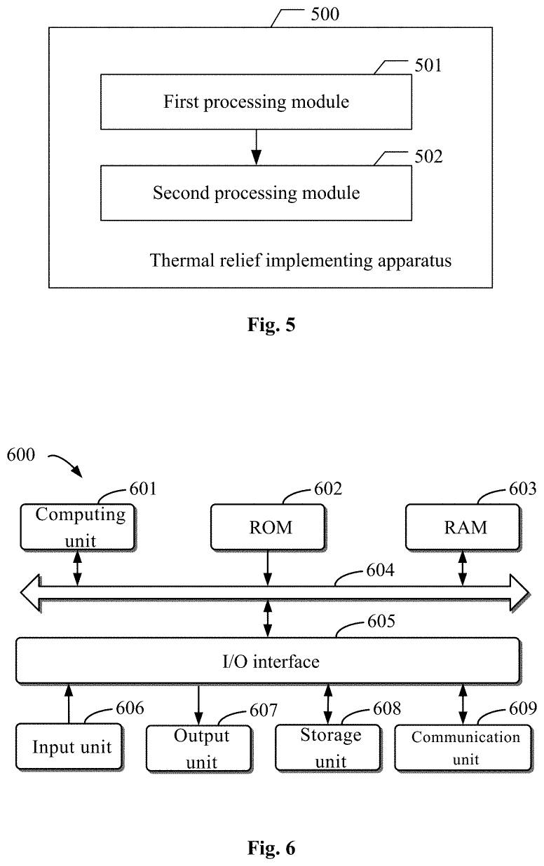

FIG. 5 is a schematic structural diagram of a thermal relief implementing apparatus 500 according to an embodiment of the present disclosure. As shown in FIG. 5, the thermal relief implementing apparatus includes a first processing module 501 configured to, determine a number of reflow holes for any pin, and determine a number of connection layers for thermal relief connection according to the number of the reflow holes; and a second processing module 502 configured to adjust at least one parameter of: the number of the reflow holes, the number of the connection layers, or widths of connection points of at least one layer, until a predetermined heat dissipation constraint and an impedance design requirement are met, and take current parameter values as required thermal-relief design parameters.

In the solution of the above-mentioned apparatus embodiment, any of multiple parameters, such as the number of the reflow holes, the number of the connection layers, the widths of the connection points, or the like, may be adjusted, such that designed thermal relief may meet the heat dissipation constraint and impedance design requirement at the same time, that is, considers lower return path impedance and better processability at the same time, thereby guaranteeing integrity of signals as far as possible, and solving a poor welding problem, a sealing-off problem, and other welding problems as far as possible.

For any pin required to be processed using a thermal relief method, the first processing module 501 may determine the number of the reflow holes firstly, and the reflow holes may also be called via holes.

In one embodiment of the present disclosure, the reflow holes may be uniformly distributed within a predetermined range around the pin. A specific value of the predetermined range may be determined according to actual requirements, for example, may be less than 30 mils.

The specific number of the reflow holes may also be determined according to actual requirements, for example, may be an initial value set experientially.

Then, the first processing module 501 may determine the number of the connection layers for thermal relief connection according to the number of the reflow holes. In one embodiment of the present disclosure, the first processing module 501 may calculate the sum of the number of the reflow holes and 1 to obtain a first calculation result, and calculate a ratio of a maximum connectable layers' number to the first calculation result to obtain a second calculation result, and the number of the connection layers is less than or equal to the maximum connectable layers' number; and then, the first processing module 501 may round the second calculation result up to an integer, so as to obtain a third calculation result, and then, may use an integer greater than or equal to the third calculation result as the required number of the connection layers.

After the number of the connection layers is determined, the second processing module 502 may adjust at least one of the number of the reflow holes, the number of the connection layers, and the widths of the connection points of the at least one layer until the predetermined heat dissipation constraint and impedance design requirement are met.

In one embodiment of the present disclosure, in response to determining that the heat dissipation constraint is met, the second processing module 502 may perform a first processing operation, otherwise, adjust the widths of the connection points of the at least one layer until the heat dissipation constraint is met, and then perform the first processing operation; and the first processing operation may include: simulating an impedance change of the reflow hole, and in response to determining that the impedance design requirement is met according to a simulation result, adjusting at least one of the number of the reflow holes, the number of the connection layers or the widths of the connection points of the at least one layer until the impedance design requirement is met.

In one embodiment of the present disclosure, the second processing module 502 may further determine connection types of respective connection layers, and correspondingly determine whether the heat dissipation constraint is met according to the number of the connection layers, the widths of the connection points of the layers, the number of the connection points corresponding to the connection types of the respective connection layers, or the like.

In one embodiment of the present disclosure, every two adjacent connection layers may be spaced apart by the same number of non-connection layers. The non-connection layers for spacing may be connected through the reflow holes to meet a signal ground return requirement; that is, the grounding return of the signals is realized. In one embodiment of the present disclosure, full connection of the maximum number of connectable layers may be realized through the reflow holes.

In one embodiment of the present disclosure, a method for determining whether the heat dissipation constraint is met by the second processing module 502 may include: taking any layer as a to-be-processed layer, and performing the following processing operations: obtaining a product of a number of connection points of the to-be-processed layer, widths of the connection points of the to-be-processed layer, a thickness of the to-be-processed layer and a heat dissipation coefficient per unit width and unit thickness, to obtain a fourth calculation result, obtaining the sum of the fourth calculation results corresponding to each of the connection layers to obtain a fifth calculation result, and determining that the heat dissipation constraint is met if the fifth calculation result is less than or equal to a heat dissipation rate corresponding to a pin.

After the heat dissipation constraint is determined to be met, the second processing module 502 may further simulate the impedance change of the reflow hole by an impedance simulation tool, and in response to determining that the impedance design requirement is met according to a simulation result, adjust at least one of the number of the reflow holes, the number of the connection layers and the widths of the connection points of the at least one layer until the impedance design requirement is met.

Whether the adjustment is performed or not, once the impedance design requirement is determined to be met, the second processing module 502 may perform the subsequent processing operation, and the subsequent processing operation may include: taking current parameter values as required thermal-relief design parameters, that is, taking the current number of the reflow holes, the current number of the connection layers, the current widths of the connection points, or the like, as the final thermal-relief design parameters.

In one embodiment of the present disclosure, the subsequent processing operation may also include: determining whether the heat dissipation constraint is met, if yes, taking the current parameter values as the required thermal-relief design parameters, if no, adjusting the widths of the connecting points of the at least one layer until the heat dissipation constraint is met, and taking the current parameter values as the required thermal-relief design parameters.

For the specific work flow of the embodiment of the apparatus shown in FIG. 5, reference may be made to the related description in the foregoing embodiment of the method.

In a word, in the solution of the apparatus embodiment of the present disclosure, the lower return path impedance and the better processability may be considered at the same time, and the reliability of the DIP connector in the use process is improved.

The solution of the present disclosure may be applied to the field of artificial intelligence, and particularly relates to the field of artificial intelligence chips, or the like. Artificial intelligence is a subject of researching how to cause a computer to simulate certain thought processes and intelligent behaviors (for example, learning, inferring, thinking, planning, or the like) of a human, and includes both hardware-level technologies and software-level technologies. Generally, the hardware technologies of the artificial intelligence include technologies, such as a sensor, a dedicated artificial intelligence chip, cloud computing, distributed storage, big data processing, or the like; the software technologies of the artificial intelligence mainly include a computer vision technology, a voice recognition technology, a natural language processing technology, a machine learning/deep learning technology, a big data processing technology, a knowledge graph technology, or the like.

In the technical solution of the present disclosure, the collection, storage, usage, processing, transmission, provision, disclosure, or the like, of involved user personal information are in compliance with relevant laws and regulations, and do not violate public order and good customs.

According to the embodiment of the present disclosure, there are also provided an electronic device, a readable storage medium and a computer program product.

FIG. 6 shows a schematic block diagram of an electronic device 600 which may be configured to implement the embodiments of the present disclosure. The electronic device is intended to represent various forms of digital computers, such as laptop computers, desktop computers, workstations, servers, blade servers, mainframe computers, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be exemplary only, and are not meant to limit implementation of the present disclosure described and/or claimed herein.

As shown in FIG. 6, the device 600 includes a computing unit 601 which may perform various appropriate actions and processing operations according to a computer program stored in a read only memory (ROM) 602 or a computer program loaded from a storage unit 608 into a random access memory (RAM) 603. Various programs and data necessary for the operation of the device 600 may be also stored in the RAM 603. The computing unit 601, the ROM 602, and the RAM 603 are connected with one other through a bus 604. An input/output (I/O) interface 605 is also connected to the bus 604.

The plural components in the device 600 are connected to the I/O interface 605, and include: an input unit 606, such as a keyboard, a mouse, or the like; an output unit 607, such as various types of displays, speakers, or the like; the storage unit 608, such as a magnetic disk, an optical disk, or the like; and a communication unit 609, such as a network card, a modem, a wireless communication transceiver, or the like. The communication unit 609 allows the device 600 to exchange information/data with other devices through a computer network, such as the Internet, and/or various telecommunication networks.

The computing unit 601 may be a variety of general and/or special purpose processing components with processing and computing capabilities. Some examples of the computing unit 601 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 601 performs the methods and processing operations described above, such as the method according to the present disclosure. For example, in some embodiments, the method according to the present disclosure may be implemented as a computer software program tangibly contained in a machine readable medium, such as the storage unit 608. In some embodiments, part or all of the computer program may be loaded and/or installed into the device 600 via the ROM 602 and/or the communication unit 609. When the computer program is loaded into the RAM 603 and executed by the computing unit 601, one or more steps of the method according to the present disclosure may be performed. Alternatively, in other embodiments, the computing unit 601 may be configured to perform the method according to the present disclosure by any other suitable means (for example, by means of firmware).

Various implementations of the systems and technologies described herein above may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input device, and at least one output device.

Program codes for implementing the method according to the present disclosure may be written in any combination of one or more programming languages. These program codes may be provided to a processor or a controller of a general purpose computer, a special purpose computer, or other programmable data processing devices, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server or a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A thermal relief implementing method, comprising:
determining a number of reflow holes for any pin, and determining a number of connection layers for thermal relief connection according to the number of the reflow holes; and
adjusting at least one parameter of: the number of the reflow holes, the number of the connection layers, or widths of connection points of at least one layer, until predetermined a heat dissipation constraint and an impedance design requirement are met, and taking current parameter values as required thermal-relief design parameters.

2. The method according to claim 1, wherein the determining the number of connection layers for thermal relief connection according to the number of the reflow holes comprises:
calculating the sum of the number of the reflow holes and 1 to obtain a first calculation result;
calculating a ratio of a maximum connectable layers' number to the first calculation result to obtain a second calculation result, the number of the connection layers being less than or equal to the maximum connectable layers' number;
rounding the second calculation result up to an integer, so as to obtain a third calculation result; and
using an integer greater than or equal to the third calculation result as the number of the connection layers.

3. The method according to claim 1, wherein the adjusting at least one parameter of the number of the reflow holes, the number of the connection layers, or widths of connection points of at least one layer until the predetermined heat dissipation constraint and the impedance design requirement are met comprises:
in response to determining that the heat dissipation constraint is met, performing a first processing operation, and in response to determining that the heat dissipation constraint is not met, adjusting the widths of the connection points of the at least one layer until the heat dissipation constraint is met, and then performing the first processing operation;
the first processing operation comprises: simulating the impedance change of the reflow hole, and in response to determining that the impedance design requirement is not met according to a simulation result, adjusting at least one of the number of the reflow holes, the number of the connection layers or the widths of the connection points of the at least one layer until the impedance design requirement is met.

4. The method according to claim 3, further comprising:
after the impedance design requirement is met, determining whether the heat dissipation constraint is met, and in response to determining that the heat dissipation constraint is met, taking the current parameter values as the thermal-relief design parameters, and in response to determining that the heat dissipation constraint is not met, adjusting the widths of the connecting points of the at least one layer until the heat dissipation constraint is met, and taking the current parameter values as the thermal-relief design parameters.

5. The method according to claim 3, further comprising: determining connection types of respective connection layers;
wherein the determining whether the heat dissipation constraint is met comprises: determining whether the heat dissipation constraint is met according to the number of the connection layers, the widths of the connection points of the layers, and the number of the connection points corresponding to the connection types of the respective connection layers.

6. The method according to claim 5, wherein the determining whether the heat dissipation constraint is met comprises:
taking any layer as a to-be-processed layer, and performing the following processing operations: obtaining a product of: a number of connection points of the to-be-processed layer, widths of the connection points of the to-be-processed layer, a thickness of the to-be-processed layer, and a heat dissipation coefficient per unit width and unit thickness, to obtain a fourth calculation result;
obtaining the sum of the fourth calculation result corresponding to each of the connection layers to obtain a fifth calculation result; and
determining that the heat dissipation constraint is met if the fifth calculation result is less than or equal to a heat dissipation rate corresponding to the pin.

7. The method according to claim 1,
wherein the reflow holes are distributed within a predetermined range around the pin.

8. The method according to claim 1,
wherein full connection of the maximum connectable layers' number is realized through the reflow holes, and the number of the connection layers is less than or equal to the maximum connectable layers' number.

9. The method according to claim 1,
wherein adjacent connection layers are spaced apart by the same number of non-connection layers.

10. An electronic device, comprising:
at least one processor; and
a memory connected with the at least one processor communicatively;
wherein the memory stores instructions executable by the at least one processor to cause the at least one processor to perform a thermal relief implementing method comprising:
determining a number of reflow holes for any pin, and determining a number of connection layers for thermal relief connection according to the number of the reflow holes; and
adjusting at least one parameter of: the number of the reflow holes, the number of the connection layers, or widths of connection points of at least one layer, until predetermined a heat dissipation constraint and an impedance design requirement are met, and taking current parameter values as required thermal-relief design parameters.

11. The electronic device according to claim 10, wherein the determining the number of connection layers for thermal relief connection according to the number of the reflow holes comprises:
calculating the sum of the number of the reflow holes and 1 to obtain a first calculation result;
calculating a ratio of a maximum connectable layers' number to the first calculation result to obtain a second calculation result, the number of the connection layers being less than or equal to the maximum connectable layers' number;
rounding the second calculation result up to an integer, so as to obtain a third calculation result; and
using an integer greater than or equal to the third calculation result as the number of the connection layers.

12. The electronic device according to claim 10, wherein the adjusting at least one parameter of the number of the reflow holes, the number of the connection layers, or widths of connection points of at least one layer until the predetermined heat dissipation constraint and the impedance design requirement are met comprises:
in response to determining that the heat dissipation constraint is met, performing a first processing operation, and in response to determining that the heat dissipation constraint is not met, adjusting the widths of the connection points of the at least one layer until the heat dissipation constraint is met, and then performing the first processing operation;
the first processing operation comprises: simulating the impedance change of the reflow hole, and in response to determining that the impedance design requirement is not met according to a simulation result, adjusting at least one of the number of the reflow holes, the number of the connection layers or the widths of the connection points of the at least one layer until the impedance design requirement is met.

13. The electronic device according to claim 12, wherein the method further comprises:
after the impedance design requirement is met, determining whether the heat dissipation constraint is met, and in response to determining that the heat dissipation constraint is met, taking the current parameter values as the thermal-relief design parameters, and in response to determining that the heat dissipation constraint is not met, adjusting the widths of the connecting points of the at least one layer until the heat dissipation constraint is met, and taking the current parameter values as the thermal-relief design parameters.

14. The electronic device according to claim 12, wherein the method further comprises: determining connection types of respective connection layers;
wherein the determining whether the heat dissipation constraint is met comprises: determining whether the heat dissipation constraint is met according to the number of the connection layers, the widths of the connection points of the layers, and the number of the connection points corresponding to the connection types of the respective connection layers.

15. The electronic device according to claim 14, wherein the determining whether the heat dissipation constraint is met comprises:
taking any layer as a to-be-processed layer, and performing the following processing operations: obtaining a product of: a number of connection points of the to-be-processed layer, widths of the connection points of the to-be-processed layer, a thickness of the to-be-processed layer, and a heat dissipation coefficient per unit width and unit thickness, to obtain a fourth calculation result;
obtaining the sum of the fourth calculation result corresponding to each of the connection layers to obtain a fifth calculation result; and
determining that the heat dissipation constraint is met if the fifth calculation result is less than or equal to a heat dissipation rate corresponding to the pin.

16. A non-transitory computer readable storage medium storing computer instructions for causing a computer to perform a thermal relief implementing method comprising:
determining a number of reflow holes for any pin, and determining a number of connection layers for thermal relief connection according to the number of the reflow holes; and
adjusting at least one parameter of: the number of the reflow holes, the number of the connection layers, or widths of connection points of at least one layer, until predetermined a heat dissipation constraint and an impedance design requirement are met, and taking current parameter values as required thermal-relief design parameters.

17. The non-transitory computer readable storage medium according to claim 16, wherein the determining the number of connection layers for thermal relief connection according to the number of the reflow holes comprises:
calculating the sum of the number of the reflow holes and 1 to obtain a first calculation result;
calculating a ratio of a maximum connectable layers' number to the first calculation result to obtain a second calculation result, the number of the connection layers being less than or equal to the maximum connectable layers' number;
rounding the second calculation result up to an integer, so as to obtain a third calculation result; and
using an integer greater than or equal to the third calculation result as the number of the connection layers.

18. The non-transitory computer readable storage medium according to claim 16, wherein the adjusting at least one parameter of the number of the reflow holes, the number of the connection layers, or widths of connection points of at least one layer until the predetermined heat dissipation constraint and the impedance design requirement are met comprises:
in response to determining that the heat dissipation constraint is met, performing a first processing operation, and in response to determining that the heat dissipation constraint is not met, adjusting the widths of the connection points of the at least one layer until the heat dissipation constraint is met, and then performing the first processing operation;
the first processing operation comprises: simulating the impedance change of the reflow hole, and in response to determining that the impedance design requirement is not met according to a simulation result, adjusting at least one of the number of the reflow holes, the number of the connection layers or the widths of the connection points of the at least one layer until the impedance design requirement is met.

19. The non-transitory computer readable storage medium according to claim 18, wherein the method further comprises:
after the impedance design requirement is met, determining whether the heat dissipation constraint is met, and in response to determining that the heat dissipation constraint is met, taking the current parameter values as the thermal-relief design parameters, and in response to determining that the heat dissipation constraint is not met, adjusting the widths of the connecting points of the at least one layer until the heat dissipation constraint is met, and taking the current parameter values as the thermal-relief design parameters.

20. The non-transitory computer readable storage medium according to claim 18, wherein the method further comprises: determining connection types of respective connection layers;
wherein the determining whether the heat dissipation constraint is met comprises: determining whether the heat dissipation constraint is met according to the number of the connection layers, the widths of the connection points of the layers, and the number of the connection points corresponding to the connection types of the respective connection layers.
